(19) United States
(12) Patent Application Publication
(10) Pub. No.: US 2025/0299063 A1
(43) Pub. Date: Sep. 25, 2025

(54) ADAPTIVE MODEL EVOLUTION THROUGH IDENTIFICATION AND INTEGRATION OF NOVEL DATA PATTERNS

(71) Applicant: PAYPAL, INC., San Jose, CA (US)

(72) Inventors: Mozhdeh Rouhsedaghat, Los Angeles, CA (US); Nitin S. Sharma, San Francisco, CA (US)

(21) Appl. No.: 18/609,967

(22) Filed: Mar. 19, 2024

(51) Int. Cl. G06N 3/096; G06N 3/045

(52) U.S. Cl. CPC G06N 3/096; G06N 3/045

(57) ABSTRACT

Systems and methods for performing continual learning for neural network models for performing certain tasks based on data including applying a first neural network model to a second dataset, the first neural network model trained using a first dataset, determining a data distribution representative of the second dataset, determining a third dataset corresponding to a subset of data in the second dataset based on applying a threshold to the data distribution, the subset of data corresponding to new data patterns in the second dataset indicative of including different characteristics than data patterns in the first dataset, obtaining a second neural network model trained using the first dataset, and training the second neural network model using the third dataset to finetune a performance of the second neural network model in performing the certain tasks or other new tasks.

### FIELD

The present disclosure relates to the field of data analytics. More particularly, to adaptive continuous learning of models through identification and integration of novel data patterns.

### BACKGROUND

Events triggered on a computing network can generate a large amount of data including millions of data points. Patterns in this data are determined based on relationships and structures in the data. These patterns are typically leveraged to power predictions. In particular, neural network models trained using the pattern data can be utilized to process the network data for performing various tasks such as, for example, classification of patterns in new data. Continual learning, also referred to as lifelong learning, may be utilized to train these neural network models to enable the neural network models to adapt over time to new data and patterns.

### BRIEF DESCRIPTION OF THE DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a block diagram of a system, according to some embodiments.

FIG. 2 is a flow diagram of a method, according to some embodiments.

FIG. 3 is a diagrammatic view of a system for performing the method of FIG. 2.

FIG. 4 is a flow diagram of a method, according to some embodiments.

FIG. 5 is a flow diagram of a method, according to some embodiments.

FIG. 6 is a diagrammatic view of a system for performing the method of FIG. 2, according to some embodiments.

FIG. 7 is a flow diagram of a method, according to some embodiments.

FIG. 8 is a diagrammatic view of a system for performing the method of FIG. 2, according to some embodiments.

FIG. 9 is a flow diagram of a method, according to some embodiments.

FIG. 10 is a flow diagram of a method, according to some embodiments.

FIG. 11 is a flow diagram of a method, according to some embodiments.

FIG. 12 is a block diagram of an example system for performing the incremental learning, according to some embodiments.

FIG. 13 is a block diagram of an example computing system, according to some embodiments.

### DETAILED DESCRIPTION

Computing networks may include artificial intelligence systems such as, for example, neural network models to perform specific tasks using data in the computing network. Neural network models may be trained with training data from labeled examples also referred to as supervised learning, from both labeled and unlabeled examples also referred to as semi-supervised learning, and through other types of feedback functions. Eventually, the trained neural network models can be exposed to data which results in different determinations as compared to previous models trained on older training datasets.

Various embodiments of the present disclosure relate to systems, methods, and non-transitory computer readable media to perform operations related to continual learning of neural network models used to perform various tasks in a system and/or a computing network of the system. In some embodiments, the computing network may be associated with the system. The neural network models may be, for example, a neural network model, M. The neural network model, M, may be trained on a given dataset such as dataset, D. Based on determining a subset of data indicative of novel data patterns in another dataset, D′, the neural network model, M, may be trained using the subset of data in the dataset, D′, to finetune the performance of the neural network model in performing the given task.

According to some embodiments, the subset of data is determined based on determining data points in the dataset, D′, that correspond to novel data patterns and that exceed a certain threshold error value, as will be further described herein. The neural network model, M, which was trained on dataset, D, can be trained using the subset of data in (or from) dataset, D′, to determine a trained neural network model, M′. The trained neural network model, M′, which is finetuned using the subset of data can then be utilized to perform the given model's task such as, for example, classification of data patterns in data. In some embodiments, the data may correspond to data generated in a computing network. For example, the data may be generated based on one or more computing devices associated with one or more users interacting with one or more other computing devices in the network. In some embodiments, the dataset, D, may correspond to historical training data and the dataset, D′, may correspond to data generated during a time period after the dataset, D.

According to some embodiments, ideally, an input dataset, D′, applied to the neural network model, M, has a similar data pattern or patterns to the dataset, D. The dataset, D, being utilized to train the neural network model, M. However, the dataset, D′, may include therein new data that exhibits novel data patterns that do not resemble the data pattern or patterns in dataset, D. In this case, the performance of the neural network model, M, is likely to decrease or may fail satisfactory performance when applied to the new data such as the dataset, D′. In order to improve the performance of the neural network model, M, on data having new data patterns, the neural network model, M, may be trained on a subset of data corresponding to the novel data patterns in dataset, D′.

According to some embodiments, a system may include a processor and memory device. The memory device may be a non-transitory computer readable media having stored therein instructions executable by the processor to cause the system to perform operations related to the continual learning technique(s) as will be further described herein. The system may include a first neural network model. In some embodiments, the first neural network model may be an auto encoder neural network model. The first neural network model may be trained using a training dataset such as, for example, dataset, D. The first neural network model may be applied to a dataset such as, for example, dataset, D′. In some embodiments, the dataset, D′, may correspond to new data generated in the computing network of the system.

The first neural network model may be applied to a given dataset as input and may encode and reconstruct samples based on having a similar data distribution as the training dataset. Samples having different data patterns than the training data may fail reconstruction and a reconstruction error score may be determined for these data points that fail reconstruction. In some embodiments, the first neural network model (trained using dataset, D) may be applied to the dataset, D, and a reconstruction error may be determined for any reconstructed samples that do not resemble the known data patterns in the dataset, D. In other embodiments, the first neural network model (trained using dataset, D) may be applied to dataset, D′, and a reconstruction error may be determined for any reconstructed samples that do not resemble the known data patterns in the dataset, D.

In the reconstructed dataset output by the first neural network model, samples having a reconstruction error score exceeding a threshold error value may be indicative of novel data patterns in the data. For example, samples that exceed the threshold error value may correspond to certain data points in a data distribution that are not proximate to other data points in the distribution corresponding to known data patterns and by exceeding the threshold error value these certain data points may be indicative of novel data patterns. A subset of data may be determined from the novel data patterns in the dataset, D′. That is, the subset of data may include one or more data points in the novel data patterns in the dataset, D′.

According to various embodiments, a second neural network model (e.g., M) may then be trained using the subset of data to finetune the model's performance, the second neural network model being trained on the dataset, D. For example, in some embodiments, dataset, D′, may be input into the first neural network model and the subset of data is determined from the novel data patterns in dataset, D′. In this regard, the subset of data includes data points corresponding to novel data patterns from the dataset, D′, and that the first neural network model determined did not resemble the patterns in the training dataset, D. In some embodiments, the first neural network model, M, may be trained on a dataset such as dataset, D. The first neural network model, M, may then be trained using the subset of data from the dataset, D′. That is, the first neural network model, M, may be trained on the dataset, D, and the subset of data from dataset, D′, to determine the trained neural network model, M′.

According to some embodiments, the system may include one or more second neural network models. A second neural network model may be neural network model, M, for performing a certain type of task or tasks in the system and/or a computing network of the system. The second neural network model may be, for example, a decision model, a classification model, or another type of model capable of performing a given task or tasks. For example, the second neural network model may be a classification model for classifying data patterns in data that may be indicative of certain types of behaviors. The second neural network model may thereby be applied to data generated in a system or a computing network associated with the system to perform a given task for various downstream purposes. For example, a second neural network model, trained on a given dataset may then be finetuned using the subset of data to improve the classification of data patterns in data that are indicative of fraudulent purchases of commercial goods by one or more computing devices in the computing network. In another example, a second neural network model may be trained using the subset of data to improve classification of data patterns in data that are indicative of identity fraud. In yet another example, a second neural network model may be a decision model that is trained on a given dataset and finetuned using the subset of data to improve the decision making by the second neural network model based on the data.

The second neural network model may be trained using a training dataset such as, for example, a dataset, D. As the data generated in the computing network evolves over time, the performance of the second neural network model trained using the dataset, D, may be negatively affected. That is, as new data generated in the computing network exhibits novel data patterns that does not resemble the data patterns in the training dataset used to train the second neural network model, the second neural network model may not be able to successfully perform its task such as, for example, the classification of data patterns indicative of fraud activity in the computing network. For example, the performance of the second neural network model in classifying new types of fraud schemes in the computing network of the system may decrease.

According to some embodiments, continual learning may be performed on the second neural network model, M, using the subset of data determined by the first neural network model based on the dataset, D′. The second neural network model, M, may be trained on a given dataset such as dataset, D, and then may be trained on the subset of data in dataset, D′, to fine-tune the model's performance and to determine the neural network model, M′. The second neural network model may then be utilized in the system or in the computing network of the system for various downstream purposes. For example, the trained neural network model, M′, may be a classification model configured to classify data patterns indicative of novel types of fraud schemes that were not identifiable by the second neural network model, M, trained only on the dataset, D.

In this regard, the continual learning of the second neural network model, M, may be performed using the subset of data identified as novel data patterns in the dataset, D′. By obtaining the second neural network model, M, that is trained using dataset, D, and training the second neural network model using the subset of data from the dataset, D′, a trained neural network model, M′, may be determined that demonstrates improved performance as compared to the neural network model, M. In this regard, the neural network model, M, which was trained using dataset, D, may be fine-tuned using the subset of data in dataset, D′, to determine the trained neural network model, M′, rather than entirely retraining a neural network model using both dataset, D, and dataset, D′. The embodiments of the present disclosure improve upon other known methods and techniques for performing continual learning for training models that utilizes all or a substantial portion of the new data (e.g., D′), which is time consuming, resource intensive, and/or which can lead to catastrophic forgetting of important characteristics learned from the previous training dataset (e.g., D).

The various embodiments in the present disclosure improve upon known methods for performing continual learning that adds constraints or penalties to weightings to minimize loss function in the models and to maintain stability of the model's performance over time. Instead, the embodiments of the present disclosure perform continual learning of neural network models trained on a dataset such as dataset, D, by fine tuning the neural network model using a subset of data in the dataset, D′, that corresponds to the novel data patterns. The subset of data being determined as novel data patterns in the dataset, D′, that does not resemble the data patterns in dataset, D. In addition, in some embodiments, if the subset of data is complementary to the dataset, D, meaning that it captures different aspects or variations of the same underlying distribution from dataset, D, the fine-tuning of the second neural network model (which is trained using D) using the subset of data may enhance the model's understanding of new data and the model's performance over the model trained only on D. Moreover, fine-tuning the second neural network model on a subset of data in dataset, D′, implies minor adjustments to the model parameters so that catastrophic forgetting is mitigated.

By training the second neural network model, e.g., finetuning the model, M, using the subset of data, the various embodiments of the present disclosure also improve upon other known methods and techniques for performing continuous learning on neural network models that employs modular structures or utilizes adaptive components to adapt to new tasks. These known methods typically accomplish continual learning by modifying the model architecture to employ these modular structures or adaptive components so the previously learned information is not disrupted. The various embodiments of the present disclosure improve upon these known continual learning methods and techniques by avoiding having to modify the network architecture of the model.

The various embodiments of the present disclosure also improve upon other known methods of continual learning that stores and replays important data from past tasks during the training of new tasks to mitigate the risk of forgetting valuable information. These known methods target all of the new data (e.g., all of D′) in addition to a subset of the original, or previous iteration, training data (e.g., D) when training the model, which can result in decreased performance of the model. The embodiments of the present disclosure include the second neural network model that is trained on dataset, D, and finetuned using the subset of data as determined in the dataset, D′, which demonstrates improved performance as compared to models trained only on D, and the models trained on all of the dataset, D′, and a subset of the dataset, D.

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

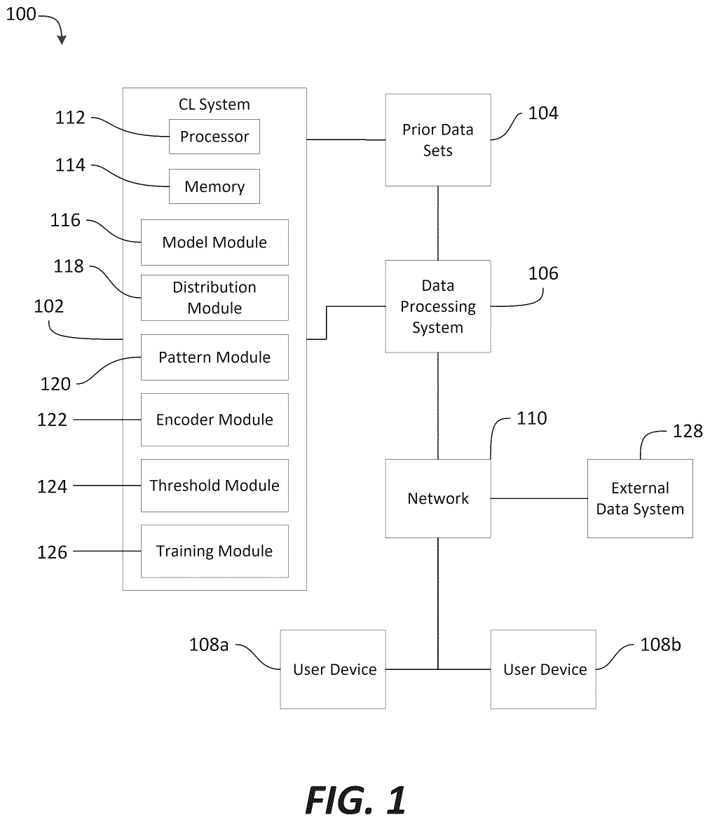

FIG. 1 is a block diagram of a system 100, according to some embodiments.

The system 100 may include a continual learning (“CL”) system 102, a source of prior datasets 104, a data processing system 106, a plurality of user devices 108 (two of such user devices 108a, 108b are shown), and one or more external data systems 128 (one external data system is shown). The plurality of user devices 108 and the one or more external data systems 128 may be in electronic communication with the data processing system 106 and with each other over a network 110. The CL system 102, prior datasets 104, and data processing system 106 may also all be in electronic communication with each other via the network 110 and/or another network.

For example, the one or more external data systems 128 may be associated with online merchants offering goods and services for sale using network 110 and the plurality of user devices 108 may be associated with users engaging in online transactions with the one or more external data systems 128 using network 110.

The prior datasets 104 may include data generated in system 100 and network 110. The prior datasets 104 may include historical data of electronic activity on system 100. In some embodiments, the prior datasets 104 may include data corresponding to the electronic activity of the plurality of user devices 108. In other embodiments, the prior datasets 104 may include data corresponding to the electronic activity of one or more external data systems 128. In yet other embodiments, the prior datasets 104 may include data corresponding to the electronic activity between plurality of user devices 108, one or more external data systems 128, other computing devices in electronic communication with system 100, or any combinations thereof. When, for example, user device 108a completes an electronic transaction with external data system 128, the data generated from the electronic activity may include a plurality of variables. In one example, the data generated from an electronic transaction may include from 1 variable to 2,000 variables. In another example, the data generated from an electronic transaction may include more than 2,000 variables. In this regard, the historical data stored in prior datasets 104 can commonly include millions of data points.

The prior datasets 104 may include training data used to train the neural network models, as will be further described herein. The training data may include labeled and unlabeled data. The data may be labeled using supervised learning, semi-supervised learning, and through other types of feedback functions such as, for example, back propagation. In some embodiments, the training data may include dataset, D, dataset, D′, subset of data from dataset, D′, other data, or any combinations thereof.

The CL system 102 may include a processor 112 and a non-transitory, computer-readable memory 114 that contains instructions that, when executed by the processor 112, cause the CL system 102 to perform one or more of the steps, processes, methods, operations, etc. described herein with respect to the CL system 102. The CL system 102 may include one or more functional modules embodied in the memory 114. The functional modules may include a model module 116, a distribution module 118, a pattern module 120, an encoder module 122, a threshold module 124, and a training module 126.

The model module 116 may include a plurality of neural network models. In some embodiments, model module 116 may include a first neural network model. The first neural network model may be utilized to produce training data based on comparing network data generated in system 100 with a training dataset. The network data may be generated as a result of electronic activity on system 100 such as, for example, based on electronic activity between plurality of user devices 108 and one or more external data systems 128.

The first neural network model may be trained using a first dataset. The model module 116 may apply the first neural network model to a second dataset to enable identifying novel data patterns in the second dataset. The first dataset may correspond to training data generated based on network data generated in system 100 or network 110 during a first time period. The second dataset may correspond to data generated in the network during a second time period. In some embodiments, the first time period occurs before the second time period. The first dataset may correspond to data patterns identified in historical data of system 100 and the second dataset may correspond to new data generated in system 100 after the first dataset was produced. In some embodiments, the first neural network model may be an auto encoder neural network model.

In some embodiments, the second dataset may include different data than the first dataset. That is, the second dataset may correspond to network data not utilized to produce the first dataset by the neural network model. In this regard, the second dataset may include one or more datapoints from the network data that may not have been previously applied to the neural network model used to generate the training data. In other embodiments, the second dataset may include at least some of the same data as the first dataset.

In some embodiments, the model module 116 may include a second neural network model. The second neural network model may be trained on a given dataset. In some embodiments, similar to the first neural network model, the second neural network model may also be trained on the first dataset. In addition, continual learning may be performed on the second neural network model by training the second neural network model using the data output by the first neural network model processing the network data. Once the second neural network model is trained on the output data of the first neural network model, the second neural network model may be utilized to analyze new network data generated in system 100. In this regard, the second neural network model may perform a given task or tasks such as, for example, classifying data patterns in the network data that may be indicative of any of a plurality of different types of electronic activity such as, but not limited to, interactions between users, commercial activity, electronic communications between users, pending activity, completed activity, fraudulent activity, identity theft, suspicious network activity, and other like electronic activity in system 100. The new network data may correspond to data generated in the system 100 or network 110 at a third time period. In some embodiments, the third time period may occur after the second time period.

It is to be appreciated by those having ordinary skill in the art that the model module 116 is not limited to the first neural network model and the second neural network model and the model module 116 may also include one or more other neural network models that may be leveraged by CL system 102 based on the particular application, and the CL system 102 may leverage the model module 116 to perform continual learning of the neural network models in accordance with the present disclosure.

The distribution module 118 may obtain data from prior datasets 104. The distribution module 118 may then apply the neural network models in model module 116 to the obtained data to enable determining data distributions of the data. In this regard, the data in the prior datasets 104 may correspond to network data generated based on electronic activity by one or more computing devices such as, for example, user devices 108 and external data system 128 in system 100. In some embodiments, the distribution module 118 may obtain the second dataset from prior datasets 104 and the distribution module 118 may apply the first neural network model to the second dataset to determine the data distribution of the second dataset. In some embodiments, the distribution module 118 may also obtain the first dataset from prior datasets 104 and the distribution module 118 may apply the first neural network model to the first dataset to determine the data distribution of the first dataset. In this regard, in some embodiments the distribution module 118 may obtain one or more datasets from prior datasets 104 and may determine the first dataset so as to enable performing the other operations of the CL system 102 as will be further described herein.

The pattern module 120 may determine data patterns in a data distribution that are similar or different to data patterns in another data distribution. In some embodiments, the first set of data patterns and the second set of data patterns comprises reconstructed samples generated based on applying the first neural network model trained using the first dataset to the second dataset. In this regard, in some embodiments, the pattern module 120 may obtain a first reconstructed dataset of the first dataset and obtain a second reconstructed dataset of the second dataset and may identify data patterns based on comparing the first reconstructed dataset to the second reconstructed dataset. The encoder module 122 and CL system 102 may determine the reconstructed datasets of the first dataset and the second dataset, as will be further described herein.

The pattern module 120 may, based on a similarity between the first dataset and the second dataset, determine a first set of data patterns in the second dataset. In some embodiments, the pattern module 120 may determine the first set of data patterns by identifying similar data patterns between the first reconstructed dataset and the second reconstructed dataset. The pattern module 120 may, based on a difference between the first dataset and the second dataset, determine a second set of data patterns in the second dataset. In some embodiments, the pattern module 120 may determine the second set of data patterns by identifying different data patterns between the first reconstructed dataset and the second reconstructed dataset. The new or different data patterns in the second set of data patterns may be indicative of particular data in the second dataset having the different characteristics from other data present in the first dataset. In some embodiments, the pattern module 120 may determine a third dataset corresponding to the new data patterns in the second dataset based on applying the error threshold to the first set of data patterns and the second set of data patterns, the error threshold being determined by the threshold module 124 and CL system 102 as will be further described herein.

The encoder module 122 may be utilized by CL system 102 to apply one or more neural network models such as, for example, the first neural network model to generate the training datasets. In some embodiments, the first neural network model may be an auto encoder.

The encoder module 122 may obtain and encode an input dataset. Encoding the input dataset includes transforming the input dataset into an encoded dataset corresponding to encoded representations of the input dataset. In some embodiments, the encoded dataset corresponds to the input dataset transformed into lower dimensional representations. For example, the encoding may include applying one or more computer algorithms to the input dataset to transform the input dataset into the encoded dataset. In some embodiments, the encoder module 122 may apply a first function to an input dataset to translate the given input dataset into encoded representations.

The encoder module 122 may also then decode the encoded dataset. Decoding the encoded dataset includes transforming the encoded dataset into a recreation of the input dataset and producing a reconstructed dataset as output. For example, the decoding may include applying one or more other computer algorithms to the encoded dataset to transform it into the output dataset. In some embodiments, a second function may be applied to the encoded dataset to translate the encoded representations into the reconstructed dataset. The CL system 102 may then determine one or more data patterns based on comparing the first dataset to the reconstructed dataset. In some embodiments, the encoding computer algorithms may be the same as the decoding computer algorithms, the encoding computer algorithms may be similar to the decoding computer algorithms, the encoding computer algorithms may be different from the decoding computer algorithms, or any combinations thereof.

The encoder module 122 may leverage the first neural network model to encode the input data into the encoded data and to decode the encoded data into the output data. In some embodiments, the encoder module 122 may leverage the first neural network model to encode the second dataset as input into an encoded dataset and to decode the encoded dataset into an output dataset. The output dataset of the second dataset may then be obtained by the other modules of CL system 102 to perform the steps, processes, methods, etc., associated with the continual learning of the neural network model such as, for example, to determine the data distribution representative of the second dataset, determine the third dataset, determine similar data patterns, determine different data patterns, and the like.

The encoder module 122 may apply the first neural network model to historical network data from a first time period to produce the first dataset. Applying the first neural network model to the network data from the first time period includes encoding the network data into encoded representations and decoding the encoded representations into a reconstructed dataset. In some embodiments, the encoder module 122 may apply the first neural network model to the first dataset. Applying the first neural network model to the first dataset includes encoding the first dataset into encoded representations of the first dataset and decoding the encoded representations of the first dataset into a reconstructed dataset of the first dataset. In some embodiments, the encoder module 122 may apply the first neural network model to the second dataset. Applying the first neural network model to the second dataset includes encoding the second dataset into encoded representations of the second dataset and decoding the encoded representations of the second dataset into a reconstructed dataset of the second dataset.

The threshold module 124 may be utilized to generate an error threshold. The error threshold may be indicative of new data patterns in a data distribution. The threshold module 124 may then apply the error threshold to data distributions to determine a set of error scores. The set of error scores may correspond to data points in the data distribution exceeding that error threshold and that correspond to novel data patterns in the data distribution.

The threshold module 124 may apply the error threshold to one or more data patterns in a data distribution that are determined as being different from another data distribution. In this regard, in some embodiments, the new data patterns may be data points in a data distribution that are different from another data distribution. In some embodiments, the error threshold may be determined by the threshold module 124 based on reconstructed data. In this regard, in some embodiments, the error threshold may be determined based on comparing reconstructed datasets to determine new data patterns between the two reconstructed datasets.

The threshold module 124 may determine the error threshold. In this regard, the error threshold may be a threshold value determined by CL system 102 by comparing the mean and standard deviation (“STD”) of reconstruction errors for the training dataset and the subset of the second dataset. That is, in some embodiments, data points in the first reconstructed dataset that failed reconstruction and data points in the second reconstructed dataset that failed reconstruction may be utilized to determine the error threshold.

The threshold module 124 may apply the first neural network model to the first dataset to determine a first set of error scores based on the first dataset. In some embodiments, the first neural network model may be applied to the first dataset to produce a first reconstructed dataset and the first set of error scores may correspond to data points that failed reconstruction. The threshold module 124 may apply the first neural network model to the second dataset to determine a second set of error scores based on the second dataset. In some embodiments, the first neural network model may be applied to the second dataset to produce a second reconstructed dataset and the second set of error scores may correspond to data points that failed reconstruction.

The threshold module 124 may then determine the error threshold based on the first set of error scores and the second set of error scores. That is, the first neural network model may be able to reconstruct samples drawn from a similar data distribution as the training dataset (e.g., first dataset), but for samples which have a different data pattern than the training dataset may fail in reconstruction by the first neural network model and the neural network model may generate a reconstruction error. The threshold module 124 may determine the error threshold by comparing the mean and standard deviation (“STD”) of the reconstruction errors of the respective first dataset and the second dataset. In this regard, the threshold module 124 may set the error threshold based on the comparison between the mean and STD of the reconstruction errors for the first dataset and the second dataset as determined based on the first neural network model to identify a subset of data in the second dataset (e.g., D′) corresponding to new data patterns that previously identified in the training data. In some embodiments, the threshold module 124 may determine the error threshold by comparing the mean and STD of the respective first reconstructed dataset and the second reconstructed dataset.

The error threshold can then be used to determine a subset of data in the second dataset corresponding to new data patterns that can be utilized to fine tune the neural network models in CL system 102. In some embodiments, the error threshold may be a threshold value determined based on calculating a mean square error value of the first set of error scores and the second set of error scores. In other embodiments, the error threshold may include a threshold value range determined based on a mean square error value of the first set of error scores and the second set of error scores.

In some embodiments, the threshold module 124 determines the error threshold based on a mean square error value of the first set of error scores and the second set of error scores. That is, the error threshold may be determined based on calculating the mean square error of the first set of error scores determined based on the second dataset and the second set of error scores determined based on the first dataset. In some embodiments, the error threshold may correspond to the sum of the squared values of the difference between the first set of error scores and the second set of error scores and divided by the number of observations. In some embodiments, the threshold module 124 may determine the mean square error may be determined using the formula:

$$M S E = \frac{1}{n} {Σ ( y - \hat{y} )}^{2} ,$$

where the first set of error scores corresponds to the actual values, y, and the second set of error scores corresponds to the predicted values, ŷ.

In this regard, the error threshold may be a dynamic threshold value determined based on the characteristics of the data points in each of the first dataset and the second dataset, and more particularly, based on the similarity and differences between the characteristics of the data points in each of the first dataset and the second dataset. In addition, the number of data points in the second set of data patterns, and which may then be used to populate the third dataset for fine tuning the neural network models such as, for example, the first neural network model and the second neural network model, may dynamically vary based on the number of data points in the data generated in the computing network which corresponds to the second dataset that failed reconstruction, and which have error scores which exceed the error threshold. Furthermore, in some embodiments, the data points that failed reconstruction but having error scores that do not exceed the error threshold may not be included in the second set of data patterns and/or the third dataset as not being indicative of new data patterns in the second dataset. For example, in some embodiments, the third dataset may include data patterns indicative of a new fraud scheme being performed by one or more user devices 108 based on the labeled variables in the data associated with the one or more user devices 108.

The training module 126 may be utilized in CL system 102 to train the neural network models. The other modules of CL system 102 may be applied to the network data to identify novel data patterns where the data points include error scores exceeding the error threshold and these new or novel data patterns may be used to train the neural network models. In some embodiments, the CL system 102 may determine a third dataset including the subset of data from dataset, D′, that corresponds to these novel data patterns. The third dataset corresponds to a selected subset of data in or from the second dataset that is determined based on applying the first neural network model to the second dataset and that exceed the error threshold.

In some embodiments, the first neural network model may be trained using the third dataset to enable identifying novel data patterns in new data. That is, to enable the first neural network model to identify novel data patterns in data generated in the network 110 of the system 100 during a time period after the time period associated with the first dataset and/or the second dataset. In some embodiments, the second neural network model may be trained using the third dataset. As the neural network models are trained on datasets such as, for example, the first dataset, the subsequent training of the models using the third dataset enables fine-tuning the neural network models performance over other known continual learning methods and techniques, and thereby can mitigate the risk of catastrophic forgetting, improves the model's overall stability over time (e.g., successive iterative cycles), prevents necessitating redesigning or reconfiguring the neural network model's architecture to perform the given task or tasks, and improves the model's performance in performing the given tasks.

The epoch size may be determined based on the error threshold. In some embodiments, the epoch size may also be determined based on the training schema of the neural network model and based on the loss functions. As used herein, the term “epoch” or “epoch size” refers to the size of the dataset used to train the neural network model in one cycle.

The CL system 102 may determine the number of data points included in the second dataset (e.g., epoch size) for determining the third dataset based on the number of data samples which have a new data pattern as compared to the first dataset. The size of the third dataset may be determined based on the error threshold, or more particularly, the amount of data points in the second dataset corresponding to new data patterns. In addition, the size of the third dataset in each epoch may be configured based on the error threshold such that the neural network models will not undergo forgetting of the past data patterns (e.g., catastrophic forgetting). In this regard, the neural network models may be overwhelmed during training if the size of the third dataset in each cycle of continual learning is too large such that past patterns are forgotten. In addition, if the deviation of the new data pattern is too large (error scores exceed an upper limit of an error threshold range), then it may be indicative of the neural network model needed a full retraining. That is, the performance of the second neural network model trained on the third dataset to perform the given task such as, for example, classifying data patterns in network data may exceed the certain threshold level, which may be indicative of the neural network models requiring full retraining.

According to some embodiments, the CL system 102 may utilize the modules 116, 118, 120, 122, 124, and 126 to apply the first neural network model to a second dataset, the first neural network model being trained on a first dataset, determine a data distribution representative of the second dataset, determine an error threshold to identify new data patterns in the second dataset, determine a third dataset corresponding to the new data patterns in the second dataset based on applying the error threshold to the first set of data patterns and the second set of data patterns, obtain a second neural network model trained using the first dataset, and trains the second neural network model using the third dataset. In some embodiments, new data patterns in the second dataset are indicative of particular data having different characteristics that other data present in the first dataset.

In some embodiments, the CL system 102 utilizing the modules 116, 118, 120, 122, 124, and 126 to determine a data distribution representative of the second dataset may include determining a first set of data patterns in the second dataset based on a similarity with a data distribution of the first dataset, determining a second set of data patterns in the second dataset based on a difference with the data distribution of the first dataset.

In addition, the CL system 102 may utilize modules 116, 118, 120, 122, 124, and 126 to apply the second neural network model (trained using the third dataset and the first dataset) to new data generated in the network to perform the given task such as, for example, classifying data patterns indicative of a certain type of activity in the computing network 110. In some embodiments, the new data corresponds to data generated in the network 110 at a third time period. In some embodiments, the third time period occurs after the second time period.

In some embodiments, the CL system 102 may utilize modules 116, 118, 120, 122, 124, and 126 to translate, based on a first function, an input dataset into an encoded representations, translate, based on a second function, the encoded representations into a reconstructed dataset, and determine one or more data patterns in the data distribution of the reconstructed dataset based on comparing the input dataset to the reconstructed dataset.

In some embodiments, the CL system 102 may utilize modules 116, 118, 120, 122, 124, and 126 to apply the first neural network model to the first dataset, determine a first reconstructed dataset based on the first dataset, determine a second reconstructed dataset based on the second dataset, determine the first set of data patterns and the second set of data patterns based on the second dataset and the second reconstructed dataset, and determine a third set of data patterns based on the first dataset and the first reconstructed dataset. In addition, in some embodiments, the CL system 102 may utilize modules 116, 118, 120, 122, and 124 to determine a first set of error scores based on the second set of data patterns, determine a second set of error scores based on the third set of data patterns, and determine the error threshold based on the first set of error scores and the second set of error scores. In some embodiments, the error threshold comprises a threshold value range determined based on a mean square error value of the first set of error scores and the second set of error scores.

In one example, the first dataset includes data patterns indicative of electronic activity of user device 108a on network 110 identified as using the identity of a user associated with user device 108b, and the third dataset includes data patterns indicative of electronic activity of user device 108a on network 110 identified as using the identity of one or more other user devices other than the identity of user device 108a.

In another example, the first dataset includes data patterns indicative of a plurality of user devices 108 engaging in electronic transactions on network 110 and where the personal identifying information (“PII”) of those users such as, but not limited to, IP address, MAC address, physical address, credit card information, social security number, or any other PII, may have been compromised and the third dataset includes data patterns indicative of other user devices 108 in system 100 where the PII of those users has been compromised.

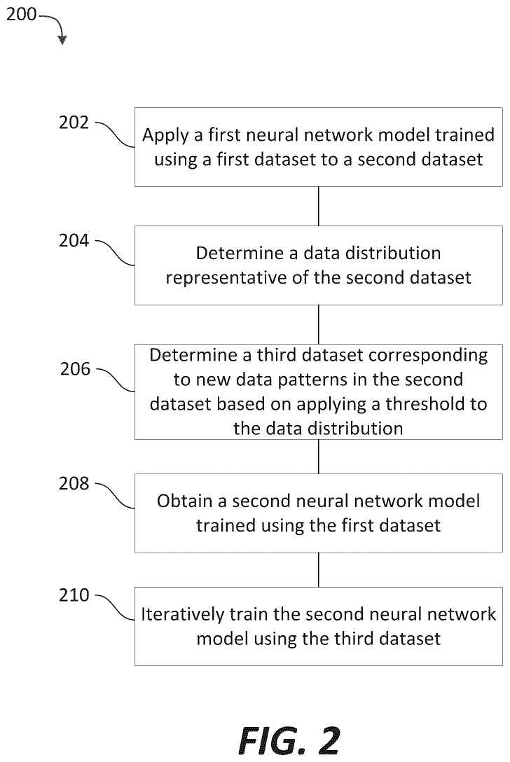

FIG. 2 is a flow diagram of a method 200, according to some embodiments. The method 200, or one or more portions of the method 200, may be performed by the CL system 102, and thus may be computer-implemented.

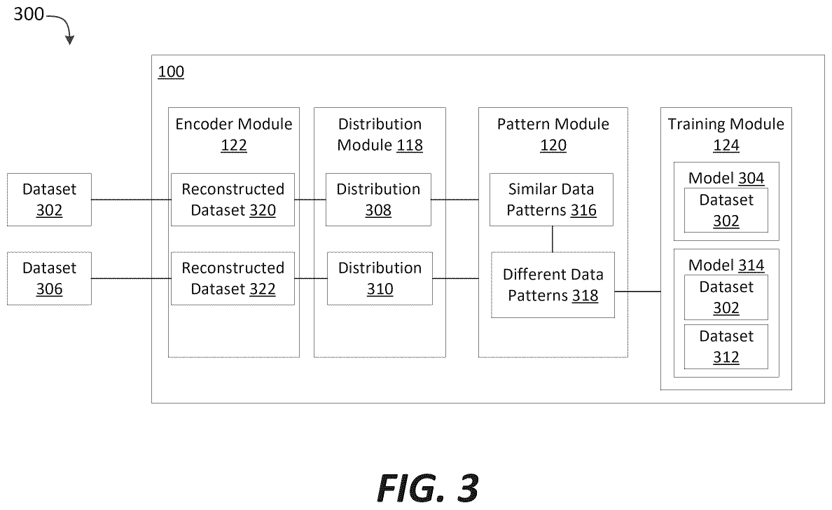

FIG. 3 is a diagrammatic view of a system 300 for performing the method 200 of FIG. 2. The method 200 will be described in conjunction with system 300.

At 202, the method 200 includes applying a first neural network model to a second dataset. The first neural network model was trained using a first dataset. In some embodiments, the first dataset may be a training dataset. In some embodiments, the first dataset corresponds to network data generated during a first time period. In other embodiments, the first dataset may be training data determined based on network data generated during the first time period. Referring to FIG. 3, the first dataset is shown as dataset 302, and the first neural network model is shown as model 304.

At 204, the method 200 includes determining a data distribution representative of the second dataset. That is, the second dataset may be applied as input to the first neural network model and a second reconstructed dataset may be provided by the first neural network model as output. In some embodiments, the second dataset may be network data. In addition, in some embodiments, the second dataset may be network data generated during a second time period. The first time period occurs before the second time period. In this regard, the second dataset corresponds to network data generated during a time period after the network data from which the first dataset is based. Referring to FIG. 3, the second dataset is shown as dataset 306, the distribution of the first dataset is shown as distribution 308, and the distribution of the second dataset is shown as distribution 310.

At 206, the method 200 includes determining a third dataset corresponding to new data patterns in the second dataset, the third dataset including data points determined based on applying a threshold error value to a second data distribution of the second dataset. In some embodiments, the new data patterns in the second dataset are indicative of particular data having different characteristics than other data present in the first dataset. That is, the third dataset may be a subset of the second dataset corresponding to new data patterns in the second dataset that failed reconstruction by the first neural network model. An error score is determined for the samples in the second dataset that failed reconstruction and the error scores that exceed the threshold are indicative of having different characteristics than the known data patterns present in the first dataset. The third dataset is shown as third dataset 312 in FIG. 3.

The third dataset may be determined based on new data patterns in the data distribution representative of the second dataset having different data patterns than data patterns in the data distribution representative of the first dataset. In some embodiments, the third dataset may include one or more data points of the new data patterns, the one or more data points being determined based on an error score associated with each of the one or more data points exceeding a threshold error value.

In some embodiments, the method 200 includes determining the threshold error value based on the first dataset and the second dataset. In some embodiments, the threshold error value may be determined based on samples in the first data distribution and the second data distribution that fail reconstruction. That is, an error score is determined for the data points in the first data distribution and the second data distribution that are different from the known data patterns in the training dataset, and the threshold error score is determined based on the error scores of these different data points that fail reconstruction. In some embodiments, the threshold error score may be determined by using any of a plurality of techniques including, but not limited to, mean squared error (MSE), root mean squared error (RMSE), mean absolute error (MAE), cross-entropy, cosine similarity, binary score, Euclidean difference, Jaccard index, Hamming distance, other like approaches, or any combinations thereof. For example, in some embodiments, the threshold error value may correspond to a MSE of the error scores associated with the samples in the first data distribution and the second data distribution that fail reconstruction. In another example, the threshold error value may correspond to a RMSE of the error scores associated with the samples in the first data distribution and the second data distribution that fail reconstruction. In another example, the threshold error value may be determined based on a cross-entropy of the error scores associated with the samples in the first data distribution and the second data distribution that fail reconstruction.

In some embodiments, determining the new dataset includes encoding the first dataset and the second dataset. In some embodiments, determining the new dataset includes reconstructing the encoded first dataset and the encoded second dataset to produce the reconstructed first dataset and reconstructed second dataset. In addition, based on the reconstructed first dataset and the reconstructed second dataset, the third dataset corresponding to the new data patterns in the second dataset can be determined. In some embodiments, the third dataset may be determined based on determining the threshold using the first reconstructed dataset and the second reconstructed dataset, and then determining the third dataset from one or more samples of the second reconstructed dataset that exceed the threshold. The first reconstructed dataset is shown as reconstructed dataset 320 and the second reconstructed dataset is shown as reconstructed dataset 322 in FIG. 3.

At 208, the method 200 includes obtaining a second neural network model. In some embodiments, the second neural network model may be trained using the first dataset.

At 210, the method 200 includes training the second neural network model using the third dataset. That is, the second neural network model may be a neural network model trained using the first dataset and continual learning is performed on the second neural network model by training the second neural network model with the third dataset to fine tune the model on the novel data patterns in the subset of data from the second dataset that failed reconstructions and that exceeds the threshold. In FIG. 3, the second neural network model is shown as model 314, the first dataset is shown as 302, and the third dataset is shown as 312. In addition, in FIG. 3, the model 314 is shown as being trained on dataset 302 and dataset 312.

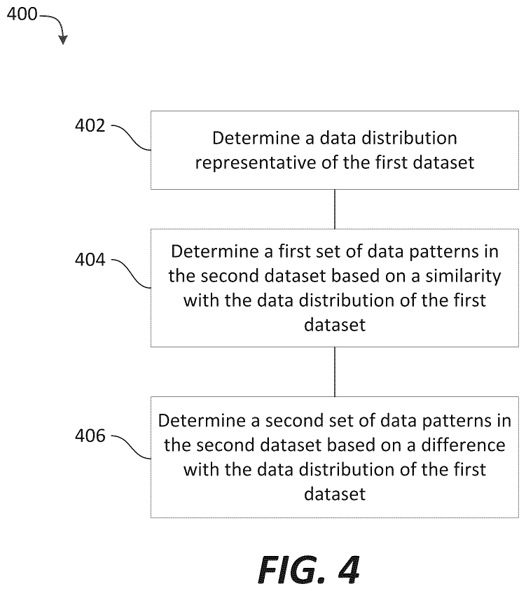

FIG. 4 is a flow diagram of a method 400, according to some embodiments. The method 400 may be an embodiment of operation 204 of the method 200 of FIG. 2. The method 400, or one or more portions of the method 400, may be performed by the CL system 102, and thus may be computer-implemented. The method 400 will be described in conjunction with the system 300.

At 402, the method 400 includes determining a data distribution representative of the first dataset. That is, the first dataset may be applied as input to the first neural network model and a first reconstructed dataset may be provided by the first neural network model as output. In some embodiments, the first dataset may be training data corresponding to identified patterns in network data generated in a network during a first time period. Referring to FIG. 3, the distribution of the first dataset is shown as distribution 308.

At 404, the method 400 includes determining a first set of data patterns in the second dataset based on a similarity with the data distribution of the first dataset. That is, the first neural network model trained using the first dataset may have the second dataset applied as input and the first neural network model may transform the second dataset into encoded representations and then transform the encoded representations into the second reconstructed dataset based on the data patterns in the first dataset. The first neural network model may thereby determine one or more data patterns in the second reconstructed dataset that have a similar data pattern as compared to the first dataset. In some embodiments, the first neural network model may determine one or more data patterns in the second reconstructed dataset having a similar data pattern as compared to the first reconstructed dataset. The similar data patterns are shown as similar data patterns 316 in FIG. 3.

At 406, the method 400 includes determining a second set of data patterns in the second dataset based on a difference with the data distribution of the first dataset. In some embodiments, the second set of data patterns includes the particular data having the different characteristics from the first dataset. In some embodiments, the first set of data patterns and the second set of data patterns includes reconstructed samples generated based on applying the first neural network model trained using the first dataset to the second dataset. That is, based on the first neural network model trained using the first dataset having the second dataset applied as input and the first neural network model transforming the second dataset into encoded representations and then transforming the encoded representations into the second reconstructed dataset based on the data patterns in the first dataset, samples in the second dataset may fail the reconstruction due to having different data patterns than the first dataset. That is, the samples in the second dataset that fails reconstruction are indicative of having different characteristics from the data patterns in the first dataset. The different data patterns is shown as different data patterns 318 in FIG. 3.

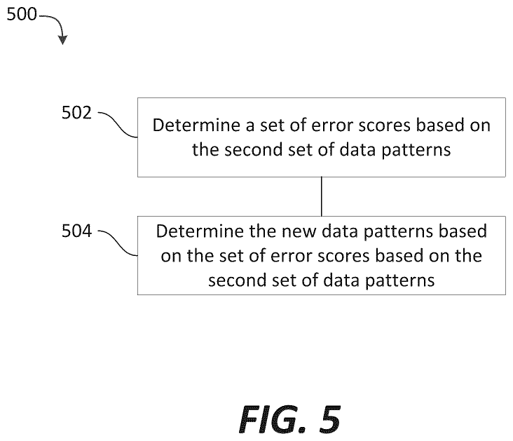

FIG. 5 is a flow diagram of a method 500, according to some embodiments. The method 500 may be an embodiment of operation 206 of the method 200 of FIG. 2. The method 500, or one or more portions of the method 500, may be performed by the CL system 102, and thus may be computer-implemented.

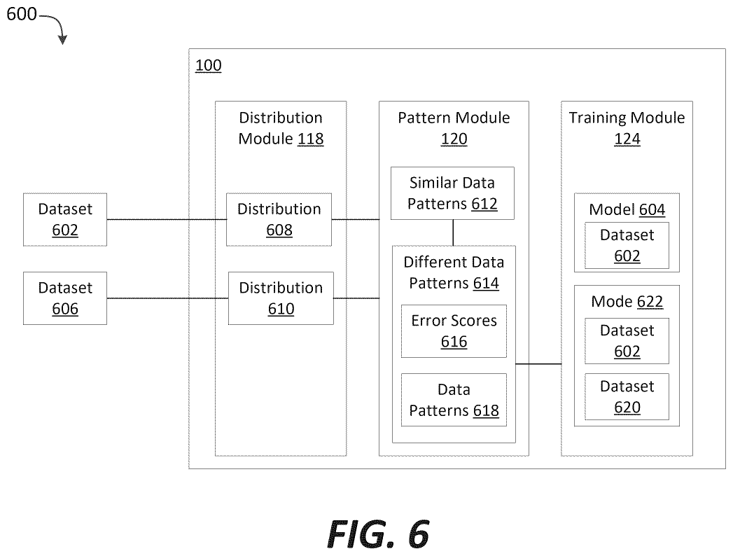

FIG. 6 is a diagrammatic view of a system 600 for performing the method 200 of FIG. 2, according to some embodiments. The method 500 will be described in conjunction with system 600.

At 502, the method 500 includes determining a set of error scores based on the second set of data patterns. In some embodiments, the first neural network model may determine a first data distribution and a second data distribution based on having the respective first dataset and second dataset applied to the first neural network model as input. The data distributions may include one or more data patterns representative of a similarity between the first dataset and the second dataset. The data distributions may also include one or more error scores for samples in the first data distribution and the second data distribution, the one or more error scores representative of a difference between the first dataset or the second dataset and the training dataset of the first neural network model (e.g., first dataset). That is, an error score may be determined for each of the samples in the distributions that fails reconstruction. For the samples in the dataset that fail reconstruction, the error score values associated therewith may be determined based on any of a plurality of characteristics of the data samples. For example, the error score values may be based on vector distances between the samples in the data distribution representative of the second dataset and the samples in the data distribution representative of the first dataset. Referring to FIG. 6, the first dataset is shown as dataset 602, the second dataset is shown as dataset 606, the first neural network model is shown as model 604, the first data distribution is shown as distribution 608, the second data distribution is shown as distribution 610, the similar data patterns are shown as similar data patterns 612, the different data patterns are shown as different data patterns 614, and the error scores are shown as 616. In some embodiments, the first dataset may be a dataset, D, the second dataset may be a dataset, D′. In some embodiments, the first neural network model may be an autoencoder neural network model.

At 504, the method 500 includes determining a new data pattern based on the set of error scores determined from the second set of data patterns in the second data distribution. In some embodiments, the new data patterns includes each data point in the second set of data patterns including an error score exceeding the threshold. That is, the data points in the second set of data patterns that have characteristics that are dissimilar to the first dataset, and which exceeds the error threshold, may be identified as indicative of new data patterns. For example, the new data patterns may be indicative of a new type of fraud activity. In some embodiments, the second set of data patterns includes data points that are dissimilar from the first dataset and the new data patterns may be identified from those data points which exceed the error threshold. In other embodiments, the second set of data patterns may consist essentially of those data points which exceed the error threshold. In some embodiments, the third dataset corresponds to a subset of data in the second set of data patterns, the data points in the third dataset being determined based on the error score associated therewith exceeding the threshold error value. In other embodiments, the third dataset consists essentially of the subset of data in the reconstructed second dataset and that exceeds the error threshold value. The new data patterns determined based on the error scores is shown as data patterns 618 in FIG. 6. The second dataset is shown as data 606. The third dataset corresponding to a subset of the second dataset that includes error scores associated therewith that exceeds a threshold error value is shown as dataset 620 in FIG. 6. The second neural network model trained using the first dataset and the third dataset corresponding to a subset of the second dataset is shown model 622.

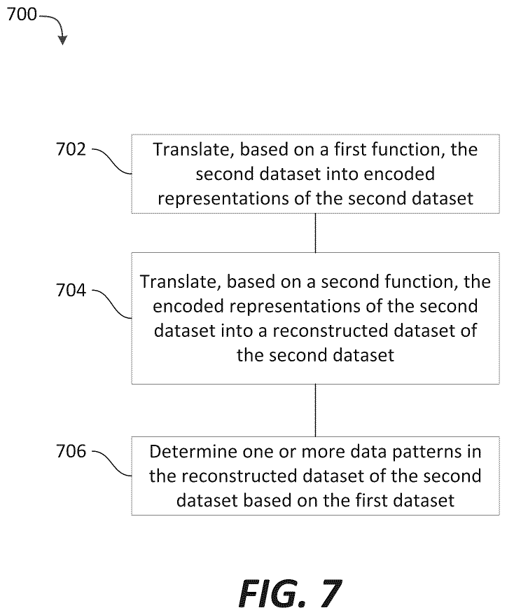

FIG. 7 is a flow diagram of a method 700, according to some embodiments. The method 700 may be an embodiment of operation 202 of method 200 in FIG. 2. The method 700, or one or more portions of the method 700, may be performed by the CL system 102, and thus may be computer-implemented.

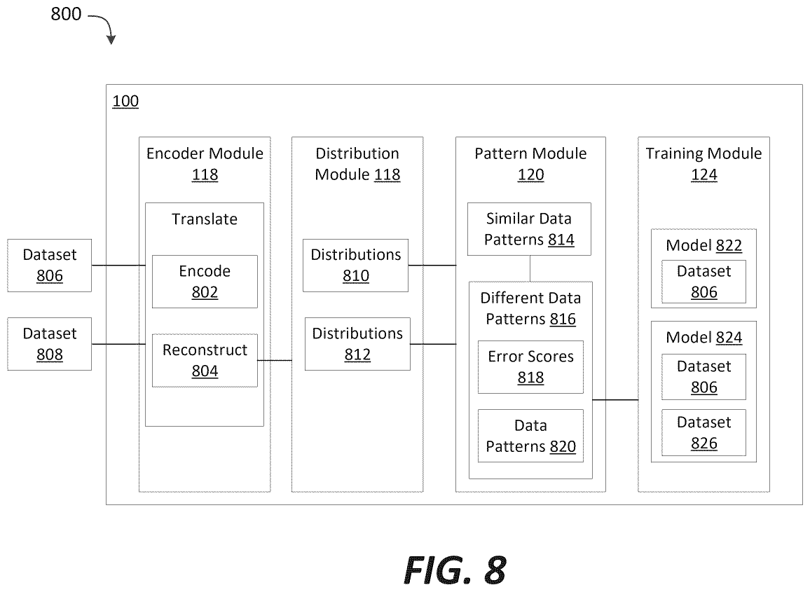

FIG. 8 is a diagrammatic view of a system 800 for performing the method 200 of FIG. 2, according to some embodiments. The method 700 will be described in conjunction with system 800.

At 702, the method 700 includes translating, based on a first function, the second dataset into encoded representations of the second dataset. In some embodiments, the first function corresponds to an algorithmic function applied to the second dataset to encode the data points in the second dataset into encoded representation. The translating of the second dataset into the encoded representations of the second dataset may be performed by the first neural network model. In some embodiments, the first neural network model may be an auto encoder neural network model. The encoding of the datasets is shown as encode 802 in FIG. 8.

At 704, the method 700 includes translating, based on a second function, the encoded representations of the second dataset into a reconstructed dataset of the second dataset. In some embodiments, the second function corresponds to an algorithmic function applied to the encoded representations of the second dataset to decode the data points in the second dataset into a reconstructed dataset. The translating of the encoded dataset of the second dataset into the reconstructed dataset of the second dataset may be performed by the first neural network model. In some embodiments, the first function may be a different function from the second function. The decoding of the encoded datasets is shown as decode 804 in FIG. 8.

At 706, the method 700 includes determining one or more data patterns in the reconstructed dataset of the second dataset based on the first dataset. In some embodiments, the one or more data patterns includes a first set of data patterns identified based on a similarity to the first dataset, and the one or more data patterns includes a second set of data patterns identified based on a dissimilarity to the first dataset.

In some embodiments, the reconstructed datasets output by the first neural network model may be provided as data distributions and the one or more data patterns are determined based on comparing the data distribution of the first dataset to the data distribution of the second dataset. That is, the reconstructed dataset of the second dataset is compared with the reconstructed dataset of the first dataset to determine the first and second set of data patterns, respectively. Referring to FIG. 8, the first dataset is shown as dataset 806, the distribution of the first dataset is shown as distributions 810, the second dataset is shown as dataset 808, and the distributions of the second dataset is shown as distributions 812. In some embodiments, the first dataset may be a dataset, D, and the second dataset may be a dataset, D′.

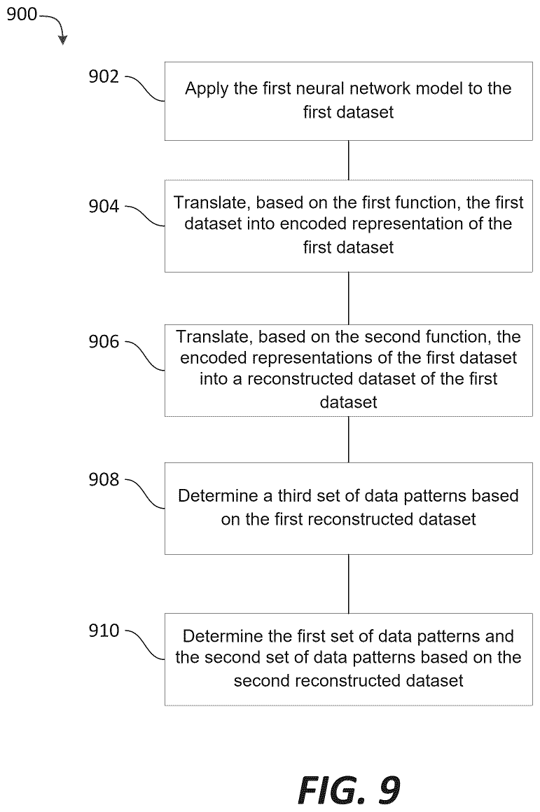

FIG. 9 is a flow diagram of a method 900, according to some embodiments. The method 900 may be an embodiment of operation 202, 204, 206 of method 200 in FIG. 2. In some embodiments, the method 900 may be an embodiment of operation 402 of method 400 in FIG. 4. The method 900, or one or more portions of the method 900, may be performed by the CL system 102, and thus may be computer-implemented. The method 900 will be described in conjunction with system 800.

At 902, the method 900 includes applying the first neural network model to the first dataset. The first neural network model may be applied to the first dataset to determine a data distribution of the first dataset for comparing the distribution of the second dataset to the distribution of the first dataset to identify the one or more data patterns in the second dataset. The first dataset is shown as 806 in FIG. 8. In some embodiments, the first dataset may be a dataset, D.

At 904, the method 900 includes translating, based on the first function, the first dataset into encoded representation of the first dataset. In some embodiments, the first function corresponds to an algorithmic function applied to the first dataset to encode the data points in the first dataset into encoded representation. In some embodiments, the first function applied to the first dataset to transform the first dataset into an encoded dataset of the first dataset is the same function as that applied to the second dataset to transform the second dataset into the encoded dataset of the second dataset. The translating of the first dataset into the encoded representations of the first dataset may be performed by the first neural network model. In some embodiments, the first neural network model may be an auto encoder neural network model. The encoding of the datasets is shown as encode 802 in FIG. 8.

At 906, the method 900 includes translating, based on the second function, the encoded representations of the first dataset into a reconstructed dataset of the first dataset. In some embodiments, the second function corresponds to an algorithmic function applied to the encoded representations of the first dataset to decode the data points in the first dataset into a reconstructed dataset of the first dataset. In some embodiments, the second function applied to the encoded dataset of the first dataset is the same function as that applied to the encoded dataset of the second dataset. The translating of the encoded dataset of the first dataset into the reconstructed dataset of the first dataset may be performed by the first neural network model. In some embodiments, the first function may be a different function from the second function. The decoding of the encoded datasets is shown as decode 804 in FIG. 8.

At 908, the method 900 includes determining a third set of data patterns based on the first reconstructed dataset. That is, the third set of data patterns corresponds to one or more known data patterns in the first dataset and determined based on translating the first dataset into the encoded dataset using the first function and then translating the encoded dataset into the reconstructed dataset using the second function. In some embodiments, the known data patterns in the first reconstructed dataset may be determined based on the similar data patterns and different data patterns identified by the first neural network model. Referring to FIG. 8, the similar data patterns is shown as similar data patterns 814, and the different data patterns is shown as different data patterns 816.

At 910, the method 900 includes determining the first set of data patterns and the second set of data patterns based on the second reconstructed dataset. In some embodiments, the first set of data patterns and the second set of data patterns are determined from the second reconstructed dataset based on the first reconstructed dataset. In some embodiments, the first set of data patterns and the second set of data patterns are determined from comparing the data distribution of the first dataset to the data distribution of the second dataset. As such, in some embodiments, the reconstructed dataset of the second dataset is determined based on the reconstructed dataset of the first dataset.

In some embodiments, the first set of data patterns corresponds to data points in the reconstructed second dataset that include characteristics similar to data points in the reconstructed first dataset, and the second set of data patterns corresponds to data points in the reconstructed second dataset that include characteristics different from the data points in the reconstructed first dataset. For the data points that are dissimilar or different from the first reconstructed dataset, an error score is determined for each data point. In some embodiments, the method 900 includes determining new data patterns based on the error scores in the different data patterns exceeding the error threshold. In addition, the second set of data patterns thereby includes data points from the reconstructed second dataset that include characteristics that are different from the first constructed dataset, and which include error scores that exceed the error threshold. Referring to FIG. 8, the error scores is shown as error scores 818, and the new data patterns is shown as data patterns 820.

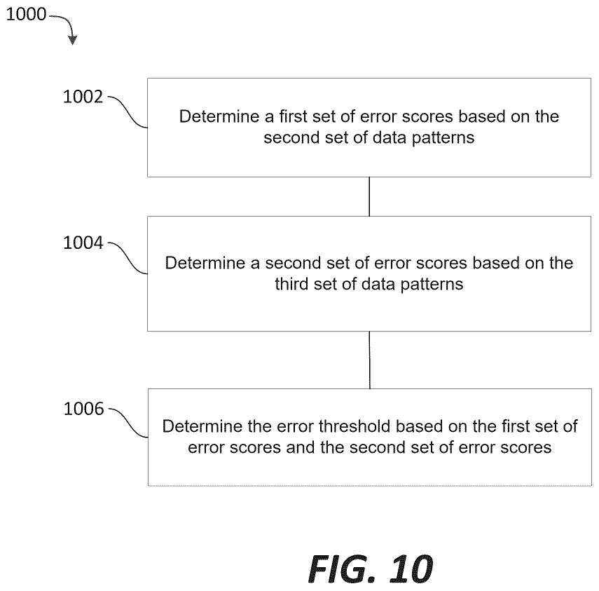

FIG. 10 is a flow diagram of a method 1000, according to some embodiments. The method 1000 may be an embodiment of operation 202, 204, 206 of method 200 in FIG. 2. In some embodiments, the method 1000 may be an embodiment of operation 404, 406 of method 400 in FIG. 4. In some embodiments, the method 1000 may be an embodiment of operation 702, 704, 706 of method 700 in FIG. 7. The method 1000, or one or more portions of the method 1000, may be performed by the CL system 102, and thus may be computer-implemented. The method 900 will be described in conjunction with system 800.

At 1002, the method 1000 includes determining a first set of error scores based on the second set of data patterns. The first set of error scores correspond to data points in the second set of data patterns having one or more characteristics that are different from the first dataset. That is, for the data points in the distribution of the reconstructed dataset of the second dataset that are different from the known data patterns in the distribution of the reconstructed first dataset and which thereby fail reconstruction, an error score may be determined for these datapoints. Referring to FIG. 8, the first set of error scores may be determined at error scores 818.

At 1004, the method 1000 includes determining a second set of error scores based on the third set of data patterns. The second set of error scores correspond to data points in the third set of data patterns having one or more characteristics that are different from the first dataset. That is, for the data points in the distribution of the reconstructed dataset of the first dataset that fail reconstruction for having characteristics that are different from the identified data patterns, an error score may be determined for these datapoints. Referring to FIG. 8, the second set of error scores may be determined at error scores 818.

At 1006, the method 1000 includes determining the error threshold based on the first set of error scores and the second set of error scores. In some embodiments, the error threshold is determined based on the mean and STD of the first set of error scores and the second set of error scores. For example, the first set of error scores may have a mean of 1.0611 and an STD of 0.5832, and the second set of error scores may have a mean of 1.389 and an STD of 0.6346. In other embodiments, the error threshold may be an error threshold range determined based on the mean and STD of the first set of error scores and the second set of error scores.

In some embodiments, the error threshold comprises a threshold value determined based on a mean square error value of the first set of error scores and the second set of error scores. That is, the error threshold may be determined based on calculating the mean square error of the first set of error scores and the second set of error scores. In some embodiments, the error threshold may correspond to the sum of the squared values of the difference between the first set of error scores and the second set of error scores and divided by the number of observations. In some embodiments, the mean square error may be determined using the formula:

$$M S E = \frac{1}{n} {Σ ( y - \hat{y} )}^{2} ,$$

where the first set of error scores corresponds to the actual values, y, and the second set of error scores corresponds to the predicted values, ŷ.

In this regard, the error threshold may be a dynamic threshold value determined based on the characteristics of the data points in each of the first dataset and the second dataset, and more particularly, based on the similarity and differences between the characteristics of the data points in each of the first dataset and the second dataset. In addition, the number of data points in the second set of data patterns, and which may then be used to populate the third dataset for fine tuning the neural network models, may dynamically vary based on the number of data points in the data generated in the computing network which corresponds to the second dataset that failed reconstruction, and which have error scores which exceed the error threshold. Furthermore, in some embodiments, the data points that failed reconstruction but having error scores that do not exceed the error threshold may not be included in the third dataset and/or the second set of data patterns as not being indicative of new data patterns in the second dataset.

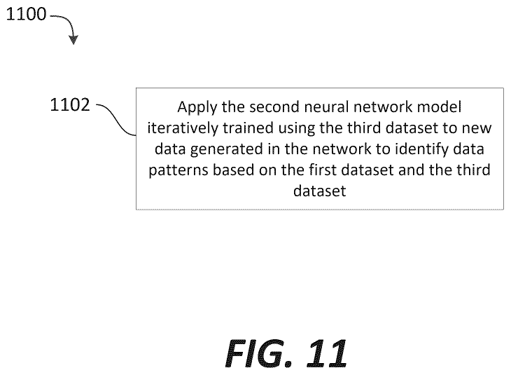

FIG. 11 is a flow diagram of a method 1100, according to some embodiments. The method 1100, or one or more portions of the method 1100, may be performed by the CL system 102, and thus may be computer-implemented. The method 1000 will be described in conjunction with system 800.

At 1102, the method 1100 includes applying the second neural network model (e.g., M′) that is trained using the third dataset (and the first dataset) to new data generated in the network 110 to perform the certain task such as, but not limited to, classifying data patterns based on the data patterns in the new data resembling data patterns in the first dataset, the third dataset, or both. In some embodiments, the second neural network model may be a neural network model trained on the first dataset, and the second neural network model may then be trained with the third dataset to finetune the model's performance. In some embodiments, training the second neural network model using the third dataset may result in a third neural network model that is trained on both the first dataset (e.g., D) and the third dataset (e.g., subset of data from D′). In this regard, continual learning is performed on the second neural network model so that the second neural network model may be applied to the network data in the system to perform the given task or tasks of the model such as classifying data patterns or making decisions based on the data. For example, the second neural network model trained on the first dataset may be trained using the third dataset to determine a trained neural network model for classifying data patterns as indicative of certain defined fraud patterns. Referring to FIG. 8, the first neural network model is shown as model 822. The second neural network model is shown as model 824 in FIG. 8. In some embodiments, the second neural network model may be a neural network model, M, trained using dataset 806, and may then be trained using dataset 826. The second neural network model trained on the first dataset (e.g., dataset 806) and the third dataset (e.g., dataset 826) is shown as model 824 in FIG. 8. That is, in some embodiments, the model 824 may be a neural network model, M′, that is trained on dataset 806 and dataset 826.

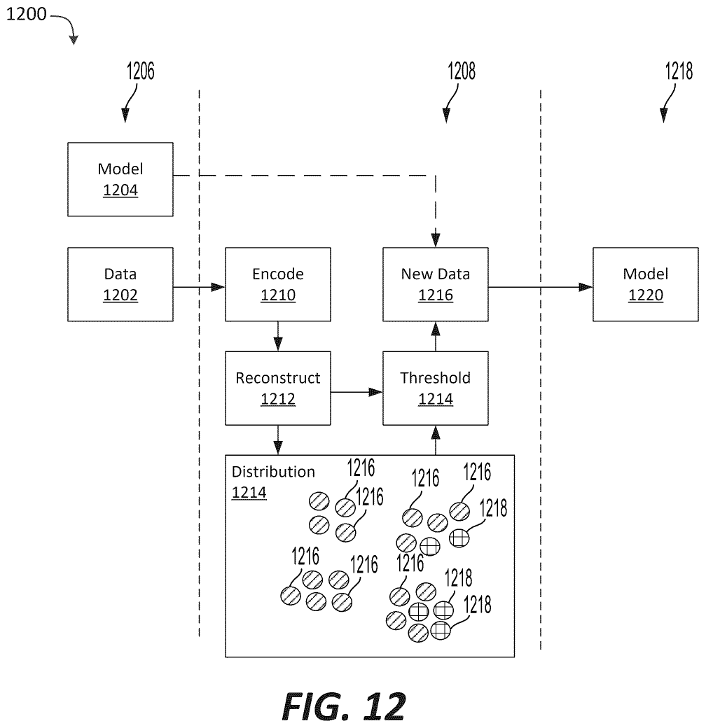

FIG. 12 is a block diagram of an example system 1200 for performing the incremental learning, according to some embodiments.

The system 1200 may obtain a dataset 1202 and a model 1204 as input 1206. The dataset 1202 may correspond to new data generated in a system such as, for example system 100 or in network 110 in FIG. 1. The model 1204 may be a previous model trained using a first dataset such as, for example, dataset 302 in FIG. 3. In some embodiments, the model 1204 may be a previous model pretrained on old classes and instances.

The system 1200 may be configured to perform incremental learning 1208. The incremental learning 1208 may include encoding 1210 the dataset 1202. In some embodiments, the encoding 1210 of the dataset 1202 may be performed using encoder module 122 in system 100. The incremental learning 1208 may also include reconstructing 1212 the dataset 1202. In some embodiments, the reconstructing 1212 of the dataset 1202 may be performed using encoder module 122 in system 100.

After the encoding 1210 and the reconstruction 1212 (e.g., decoding) of the dataset 1202, the model (e.g., auto-encoder model) may generate a distribution 1214. The distribution 1214 may include one or more data patterns corresponding to old data 1216 from previous datasets and new data 1218 which can produce reconstruction errors.

The incremental learning 1208 may also include determining a threshold 1220. In some embodiments, the threshold 1220 may be determined based on applying a model (e.g., auto-encoder model) to a previous dataset (not shown). In some embodiments, applying the model to the previous dataset may include the encoding 1210 and the reconstructing 1212 the dataset and computing the reconstruction error based on the results. In some embodiments, determining the threshold 1220 also includes applying a model (e.g., auto-encoder model) to the reconstructed dataset produced as output from reconstructing 1212 the dataset 1202.

The incremental learning 1208 may include determining new data 1222 based on applying the threshold 1220 to one or more samples from the output from reconstructing 1212 the dataset 1202. The new data 1222 corresponding to one or more data points from the reconstructing 1212 of the dataset 1202 that exceed the threshold 1220. The data points that exceed the threshold 1220 corresponding to novel data patterns in the dataset 1202. That is, the new data 1222 includes is the subset of data points from dataset 1202 that exceed the calculated threshold 1220.

The system 1200 may provide model 1226 as output 1224, according to some embodiments. The model 1226 may be trained on the previous dataset similar to the dataset used to train the model 1204. In addition, the model 1226 may be fine-tuned using the novel data patterns from new data 1222 to perform the incremental learning on the model 1204 to produce model 1226. For example, the previous model may be model 1204 trained to classify fraud attempts on the system 100 or network 110 based on determining one or more classes of data such as IP address, MAC address, and user name, and the model 1226 may be trained using new data 1222, or a subset of data thereof, to classify data patterns indicative of fraud attempts on the system 100 or network 110 based on determining one or more other classes of data such as user location, financial information, transaction history, or other types of transaction data.

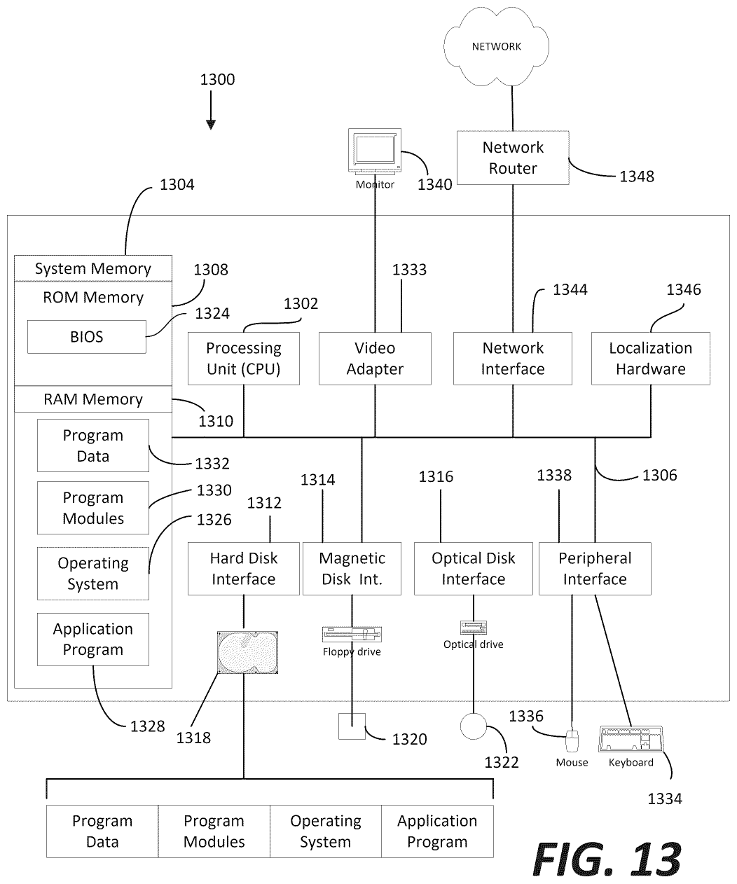

FIG. 13 is a block diagram of an example computing system 1300, such as a desktop computer, laptop, smartphone, tablet, or any other such device having the ability to execute instructions, such as those stored within a non-transient, computer-readable medium. Furthermore, while described and illustrated in the context of a single computing system 1200, those skilled in the art will also appreciate that the various tasks described hereinafter may be practiced in a distributed environment having multiple computing systems 1300 linked via a local or wide-area network in which the executable instructions may be associated with and/or executed by one or more of multiple computing systems 1300.

In its most basic configuration, computing system environment 1300 typically includes at least one processing unit 1302 and at least one memory 1304, which may be linked via a bus 1306. Depending on the exact configuration and type of computing system environment, memory 1304 may be volatile (such as RAM 1310), non-volatile (such as ROM 1308, flash memory, etc.) or some combination of the two. Computing system environment 1300 may have additional features and/or functionality. For example, computing system environment 1300 may also include additional storage (removable and/or non-removable) including, but not limited to, magnetic or optical disks, tape drives and/or flash drives. Such additional memory devices may be made accessible to the computing system environment 1300 by means of, for example, a hard disk drive interface 1312, a magnetic disk drive interface 1314, and/or an optical disk drive interface 1316. As will be understood, these devices, which would be linked to the system bus 1306, respectively, allow for reading from and writing to a hard disk 1318, reading from or writing to a removable magnetic disk 1320, and/or for reading from or writing to a removable optical disk 1322, such as a CD/DVD ROM or other optical media. The drive interfaces and their associated computer-readable media allow for the nonvolatile storage of computer readable instructions, data structures, program modules and other data for the computing system environment 1300. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 1300.

A number of program modules may be stored in one or more of the memory/media devices. For example, a basic input/output system (BIOS) 1324, containing the basic routines that help to transfer information between elements within the computing system environment 1300, such as during start-up, may be stored in ROM 1308. Similarly, RAM 1310, hard drive 1318, and/or peripheral memory devices may be used to store computer executable instructions comprising an operating system 1326, one or more applications programs 1328, other program modules 1330, and/or program data 1332. Still further, computer-executable instructions may be downloaded to the computing environment 1300 as needed, for example, via a network connection. The applications programs 1328 may include, for example, a browser, including a particular browser application and version, which browser application and version may be relevant to determinations of correspondence between communications and user URL requests, as described herein. Similarly, the operating system 1326 and its version may be relevant to determinations of correspondence between communications and user URL requests, as described herein.

An end-user may enter commands and information into the computing system environment 1300 through input devices such as a keyboard 1334 and/or a pointing device 1336. While not illustrated, other input devices may include a microphone, a joystick, a game pad, a scanner, etc. These and other input devices would typically be connected to the processing unit 1302 by means of a peripheral interface 1338 which, in turn, would be coupled to bus 1306. Input devices may be directly or indirectly connected to processor 1302 via interfaces such as, for example, a parallel port, game port, firewire, or a universal serial bus (USB). To view information from the computing system environment 1300, a monitor 1340 or other type of display device may also be connected to bus 1306 via an interface, such as via video adapter 1333. In addition to the monitor 1340, the computing system environment 1300 may also include other peripheral output devices, not shown, such as speakers and printers.

The computing system environment 1300 may also utilize logical connections to one or more computing system environments. Communications between the computing system environment 1300 and the remote computing system environment may be exchanged via a further processing device, such a network router 1348, that is responsible for network routing. Communications with the network router 1348 may be performed via a network interface component 1344. Thus, within such a networked environment, e.g., the Internet, World Wide Web, LAN, or other like type of wired or wireless network, it will be appreciated that program modules depicted relative to the computing system environment 1300, or portions thereof, may be stored in the memory storage device(s) of the computing system environment 1300.

The computing system environment 1300 may also include localization hardware 1346 for determining a location of the computing system environment 1300. In embodiments, the localization hardware 1346 may include, for example only, a GPS antenna, an RFID chip or reader, a WiFi antenna, or other computing hardware that may be used to capture or transmit signals that may be used to determine the location of the computing system environment 1300. Data from the localization hardware 1346 may be included in a callback request or other user computing device metadata in the methods of this disclosure.

The computing system, or one or more portions thereof, may embody a user computing device 108, in some embodiments. Additionally, or alternatively, some components of the computing system 1200 may embody the CL system 102 and/or data processing system 106. For example, the functional modules 116, 118, 120, 122, 124, 126 may be embodied as program modules 1330.

As used herein, the term “continual learning,” also referred to as lifelong learning, enables trained neural network models to adapt over time to new data and patterns without forgetting previously learned information.

In some embodiments, a system for performing continual learning of neural network models for performing one or more given tasks based on data generated in a network of the system, the system including: a processor; and a non-transitory computer readable media having stored thereon instructions executable by the processor to cause the system to perform operations including: applying a first neural network model to a second dataset, the first neural network model being trained using a first dataset; determining, by the first neural network model, a data distribution representative of the second dataset; determining, by the first neural network model, a third dataset corresponding to a subset of data in the second dataset based on applying a threshold to the data distribution, the subset of data corresponding to new data patterns in the second dataset indicative of including different characteristics than data patterns in the first dataset; obtaining a second neural network model trained using the first dataset; and training the second neural network model using the third dataset, the training of the second neural network model finetunes the second neural network model in performing the one or more given tasks.

In some embodiments, the first dataset corresponds to data generated in the network during a first time period, the second dataset corresponds to data generated in the network during a second time period, and the first time period occurs before the second time period.

In some embodiments, the operations further including apply the second neural network model to new data generated in the network to classify data patterns in the new data based on the first dataset and the third dataset, the new data corresponding to data generated in the network at a third time period, and the third time period occurs after the second time period.

In some embodiments, determining the data distribution representative of the second dataset includes determining, by the first neural network model, a data distribution representative of the first dataset, determining, by the first neural network model, a first set of data patterns in the second dataset based on a similarity with the data distribution of the first dataset, and determining, by the first neural network model, a second set of data patterns in the second dataset based on a difference with the data distribution of the first dataset, the second set of data patterns including one or more data points including different characteristics from one or more data points in the first dataset.

In some embodiments, the first set of data patterns and the second set of data patterns includes reconstructed samples generated based on applying the first neural network model trained using the first dataset to the second dataset.

In some embodiments, determining the third dataset corresponding to the new data patterns in the second dataset based on applying the threshold to the data distribution further includes determining a set of error scores based on the second set of data patterns, and determining the new data patterns based on the set of error scores based on the second set of data patterns, the new data patterns including each data point in the second set of data patterns including an error score exceeding the threshold.

In some embodiments, the first neural network model includes an auto encoder neural network model.

In some embodiments, a computer-implemented method for performing continual learning for neural network models trained to perform one or more tasks in a computing network, the method including: applying, by a computing device, a first neural network model to a second dataset, the first neural network model being trained using a first dataset; determining, by the first neural network model, a data distribution representative of the second dataset; determining, by the first neural network model, a third dataset corresponding to a subset of data in the second dataset based on applying an error threshold to the data distribution, the subset of data corresponding to new data patterns in the second dataset indicative of including different characteristics than data patterns in the first dataset; and training a second neural network model using the third dataset, training the second neural network model finetunes a performance of the second neural network model in performing the one or more tasks.

In some embodiments, the second neural network model includes a previous neural network model trained using the first dataset.

In some embodiments, the method further including: applying the second neural network model trained using the third dataset to new data generated in the computing network to classify data patterns based on the first dataset and the third dataset; training the second neural network model includes fine tuning the second neural network model trained using the first dataset with the third dataset so as to prevent catastrophic forgetting by the second neural network model in classifying the data patterns.

In some embodiments, the first dataset corresponds to data generated in the computing network during a first time period, wherein the second dataset corresponds to data generated in the computing network during a second time period; and wherein the first time period occurs before the second time period.

In some embodiments, determining the data distribution representative of the second dataset includes: determining, by the first neural network model, a data distribution representative of the first dataset, determining, by the first neural network model, a first set of data patterns in the second dataset based on a similarity with the data distribution of the first dataset, and determining, by the first neural network model, a second set of data patterns in the second dataset based on a difference with the data distribution of the first dataset, the first set of data patterns and the second set of data patterns including reconstructed samples generated based on applying the first neural network model trained using the first dataset to the second dataset.

In some embodiments, determining the third dataset corresponding to the new data patterns in the second dataset based on applying the error threshold to the data distribution further includes determining a set of error scores for the second set of data patterns, and determining the new data patterns based on the set of error scores for the second set of data patterns, the new data patterns includes one or more data points in the second set of data patterns, the one or more data points including respective error scores exceeding the error threshold.

In some embodiments, the method further including training the first neural network model using the third dataset, training the first neural network model enables determining data patterns in new data generated in the computing network.

In some embodiments, a non-transitory computer readable media having stored therein instructions executable by a processor to perform operations for performing continual learning of neural network models including: apply a first neural network model to a second dataset, the first neural network model trained using a first dataset; determine, by the first neural network model, a first set of data patterns in the second dataset based on a similarity with a data distribution of the first dataset; determine, by the first neural network model, a second set of data patterns in the second dataset based on differences with the data distribution of the first dataset; determine, by the first neural network model, an error threshold to identify new data patterns in the second dataset, the new data patterns in the second dataset are indicative of including different characteristics that data patterns in the first dataset; determine, by the first neural network model, a third dataset corresponding to the new data patterns in the second dataset based on applying the error threshold to the first set of data patterns and the second set of data patterns; obtain a second neural network model trained using the first dataset; and train the second neural network model using the third dataset.

In some embodiments, the first dataset corresponds to data generated in a network during a first time period, the second dataset corresponds to data generated in the network during a second time period, and the first time period occurs before the second time period.

In some embodiments, the operations further including: apply the second neural network model trained using the third dataset to new data generated in the network to classify data patterns based on the first dataset and the third dataset; the new data corresponds to data generated in the network at a third time period; and the third time period occurs after the second time period.

In some embodiments, applying the first neural network model to the second dataset includes: translate, by the first neural network model based on a first function, the second dataset into encoded representations of the second dataset, translate, by the first neural network model based on a second function, the encoded representations of the second dataset into a reconstructed dataset of the second dataset, and determine one or more data patterns in the reconstructed dataset of the second dataset based on the first dataset.

In some embodiments, the operations further including: apply the first neural network model to the first dataset, translate, by the first neural network model based on the first function, the first dataset into encoded representation of the first dataset, translate, by the first neural network model based on the second function, the encoded representations of the first dataset into a reconstructed dataset of the first dataset, determine one or more data patterns in the reconstructed dataset of the first dataset based on the first dataset, determine, by the first neural network model, the first set of data patterns and the second set of data patterns based on the second reconstructed dataset, and determine, by the first neural network model, a third set of data patterns based on the first reconstructed dataset; wherein the reconstructed dataset of the second dataset is determined based on the reconstructed dataset of the first dataset.

In some embodiments, the operations further including: determine a first set of error scores based on the second set of data patterns, determine a second set of error scores based on the third set of data patterns, and determine the error threshold based on the first set of error scores and the second set of error scores, the error threshold including a threshold value range determined based on a mean square error value of the first set of error scores and the second set of error scores.

All prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

What is claimed is:

1. A system for performing continual learning of neural network models for performing one or more given tasks based on data generated in a network of the system, the system comprising:
a processor; and
a non-transitory computer readable media having stored thereon instructions executable by the processor to cause the system to perform operations comprising:
applying a first neural network model to a second dataset, the first neural network model being trained using a first dataset;
determining, by the first neural network model, a data distribution representative of the second dataset;
determining, by the first neural network model, a third dataset corresponding to a subset of data in the second dataset based on applying a threshold to the data distribution, wherein the subset of data corresponds to new data patterns in the second dataset indicative of including different characteristics than data patterns in the first dataset;
obtaining a second neural network model trained using the first dataset; and
training the second neural network model using the third dataset, wherein training the second neural network model finetunes the second neural network model in performing the one or more given tasks.

2. The system of claim 1, wherein the first dataset corresponds to data generated in the network during a first time period,
wherein the second dataset corresponds to data generated in the network during a second time period; and
wherein the first time period occurs before the second time period.

3. The system of claim 2, wherein the operations further comprising:
apply the second neural network model to new data generated in the network to classify data patterns in the new data based on the first dataset and the third dataset,
wherein the new data corresponds to data generated in the network at a third time period, and
wherein the third time period occurs after the second time period.

4. The system of claim 1, wherein determining the data distribution representative of the second dataset comprises:
determining, by the first neural network model, a data distribution representative of the first dataset,
determining, by the first neural network model, a first set of data patterns in the second dataset based on a similarity with the data distribution of the first dataset, and
determining, by the first neural network model, a second set of data patterns in the second dataset based on a difference with the data distribution of the first dataset;
wherein the second set of data patterns comprises one or more data points including different characteristics from one or more data points in the first dataset.

5. The system of claim 4, wherein the first set of data patterns and the second set of data patterns comprises reconstructed samples generated based on applying the first neural network model trained using the first dataset to the second dataset.

6. The system of claim 4, wherein determine the third dataset corresponding to the new data patterns in the second dataset based on applying the threshold to the data distribution further comprises:
determining a set of error scores based on the second set of data patterns, and
determining the new data patterns based on the set of error scores based on the second set of data patterns,
wherein the new data patterns comprises each data point in the second set of data patterns comprising an error score exceeding the threshold.

7. The system of claim 1, wherein the first neural network model comprises an auto encoder neural network model.

8. A computer-implemented method for performing continual learning for neural network models trained to perform one or more tasks in a computing network, the method comprising:
applying, by a computing device, a first neural network model to a second dataset, wherein the first neural network model is trained using a first dataset;
determining, by the first neural network model, a data distribution representative of the second dataset;
determining, by the first neural network model, a third dataset corresponding to a subset of data in the second dataset based on applying an error threshold to the data distribution, the subset of data corresponding to new data patterns in the second dataset indicative of including different characteristics than data patterns in the first dataset; and
training a second neural network model using the third dataset, wherein training the second neural network model finetunes a performance of the second neural network model in performing the one or more tasks.

9. The computer-implemented method of claim 8, wherein the second neural network model comprises a previous neural network model trained using the first dataset.

10. The computer-implemented method of claim 9, further comprising:
applying the second neural network model trained using the third dataset to new data generated in the computing network to classify data patterns based on the first dataset and the third dataset;
wherein training the second neural network model comprises fine tuning the second neural network model trained using the first dataset with the third dataset so as to prevent catastrophic forgetting by the second neural network model in classifying the data patterns.

11. The computer-implemented method of claim 8, wherein the first dataset corresponds to data generated in the computing network during a first time period,
wherein the second dataset corresponds to data generated in the computing network during a second time period; and
wherein the first time period occurs before the second time period.

12. The computer-implemented method of claim 8, wherein determining the data distribution representative of the second dataset comprises:
determining, by the first neural network model, a data distribution representative of the first dataset,
determining, by the first neural network model, a first set of data patterns in the second dataset based on a similarity with the data distribution of the first dataset, and
determining, by the first neural network model, a second set of data patterns in the second dataset based on a difference with the data distribution of the first dataset,
wherein the first set of data patterns and the second set of data patterns comprises reconstructed samples generated based on applying the first neural network model trained using the first dataset to the second dataset.

13. The computer-implemented method of claim 12, wherein determine the third dataset corresponding to the new data patterns in the second dataset based on applying the error threshold to the data distribution further comprises:
determining a set of error scores for the second set of data patterns, and
determining the new data patterns based on the set of error scores for the second set of data patterns,
wherein the new data patterns comprises one or more data points in the second set of data patterns, the one or more data points comprising respective error scores exceeding the error threshold.

14. The computer-implemented method of claim 8, further comprising:
training the first neural network model using the third dataset,
wherein training the first neural network model enables determining data patterns in new data generated in the computing network.

15. A non-transitory computer readable media having stored therein instructions executable by a processor to perform operations for performing continual learning of neural network models comprising:
apply a first neural network model to a second dataset, wherein the first neural network model is trained using a first dataset;
determine, by the first neural network model, a first set of data patterns in the second dataset based on a similarity with a data distribution of the first dataset;
determine, by the first neural network model, a second set of data patterns in the second dataset based on differences with the data distribution of the first dataset;
determine, by the first neural network model, an error threshold to identify new data patterns in the second dataset, wherein the new data patterns in the second dataset are indicative of including different characteristics that data patterns in the first dataset;
determine, by the first neural network model, a third dataset corresponding to the new data patterns in the second dataset based on applying the error threshold to the first set of data patterns and the second set of data patterns;
obtain a second neural network model trained using the first dataset; and
train the second neural network model using the third dataset.

16. The non-transitory computer readable media of claim 15, wherein the first dataset corresponds to data generated in a network during a first time period, the second dataset corresponds to data generated in the network during a second time period, and the first time period occurs before the second time period.

17. The non-transitory computer readable media of claim 16, wherein the operations further comprising:
apply the second neural network model trained using the third dataset to new data generated in the network to classify data patterns based on the first dataset and the third dataset;
wherein the new data corresponds to data generated in the network at a third time period; and
wherein the third time period occurs after the second time period.

18. The non-transitory computer readable media of claim 15, wherein applying the first neural network model to the second dataset comprises:
translate, by the first neural network model based on a first function, the second dataset into encoded representations of the second dataset,
translate, by the first neural network model based on a second function, the encoded representations of the second dataset into a reconstructed dataset of the second dataset, and
determine one or more data patterns in the reconstructed dataset of the second dataset based on the first dataset.

19. The non-transitory computer readable media of claim 18, wherein the operations further comprising:
apply the first neural network model to the first dataset,
translate, by the first neural network model based on the first function, the first dataset into encoded representation of the first dataset,
translate, by the first neural network model based on the second function, the encoded representations of the first dataset into a reconstructed dataset of the first dataset,
determine one or more data patterns in the reconstructed dataset of the first dataset based on the first dataset,
determine, by the first neural network model, the first set of data patterns and the second set of data patterns based on the second reconstructed dataset, and
determine, by the first neural network model, a third set of data patterns based on the first reconstructed dataset;
wherein the reconstructed dataset of the second dataset is determined based on the reconstructed dataset of the first dataset.

20. The non-transitory computer readable media of claim 19, wherein the operations further comprising:
determine a first set of error scores based on the second set of data patterns,
determine a second set of error scores based on the third set of data patterns, and
determine the error threshold based on the first set of error scores and the second set of error scores,
wherein the error threshold comprises a threshold value range determined based on a mean square error value of the first set of error scores and the second set of error scores.
